(19) United States
(12) Patent Application Publication
(10) Pub. No.: US 2024/0110666 A1
(43) Pub. Date: Apr. 4, 2024

(54) ADJUSTABLE OVERHEAD MOUNTABLE STORAGE SYSTEM CONFIGURED TO RECEIVE STORAGE BINS

(71) Applicant: Dwayne Dunseath, Las Vegas, NV (US)

(72) Inventor: Dwayne Dunseath, Las Vegas, NV (US)

(21) Appl. No.: 18/538,199

(22) Filed: Dec. 13, 2023

Related U.S. Application Data
(63) Continuation-in-part of application No. 16/801,020, filed on Feb. 25, 2020.
(60) Provisional application No. 62/810,302, filed on Feb. 25, 2019.
(60) Provisional application No. 63/588,011, filed on Oct. 5, 2023.

(51) Int. Cl. F16M 13/02

(52) U.S. Cl. CPC F16M 13/027

(57) ABSTRACT

A storage system includes at least two support rails extending in a first longitudinal direction and attachable to a rigid overhead structure in a first fixed lateral spaced relationship. At least two tracks extend in a second longitudinal direction that is transverse to the first longitudinal direction. The tracks are slidably retained and supported by the support rails and slidable in the first longitudinal direction relative to the support rails. The tracks are fixable relative to the support rails in second fixed lateral spaced relationship that is transverse to the first lateral fixed spaced relationship. The tracks include lower platforms that extend laterally outward and define a path within the second fixed lateral spaced relationship to receive and support opposite ends of one or more storage bins such that the lower platforms on opposite sides of the path collectively support the storage bins.

### CROSS REFERENCE TO RELATED APPLICATIONS

This application is a Continuation-in-Part of U.S. patent application Ser. No. 16/801,020 filed Feb. 25, 2020, which claims priority to U.S. Provisional Patent Application No. 62/810,302 filed Feb. 25, 2019. This application also claims priority to U.S. Provisional Patent Application No. 63/588,011 filed Oct. 5, 2023. Each of the above-listed applications are incorporated herein by reference for all purposes.

### FIELD OF THE INVENTION

The embodiments of the present invention relate to an overhead storage system mountable to a ceiling or other overhead structure and configured to receive storage bins.

### BACKGROUND

Storage space is very much at a premium m most homes, including garages. Unfortunately, after vehicles are parked in the garage, available storage space is lacking. In most cases, the space proximate the ceiling is available even when vehicles are parked in the garage. In other words, vehicles are not typically tall enough to occupy the space proximate the garage ceiling.

It would thus be advantageous to develop a storage system mountable on a ceiling or other overhead structure.

### SUMMARY

One embodiment of the present invention is directed to a system comprising at least two support rails attachable to a rigid overhead structure to a rigid in a parallel spaced arrangement; at least two I-beam tracks, each I-beam track configured to slidably attach to each of said at least two support rails in a spaced relationship, said at least two I-beam tracks each having lower platforms defining a path in said spaced relationship to receive and support opposite ends of one or more storage bins such that each of said I-beam tracks collectively support each of said one or more storage bins; and wherein said support rails include support rail extensions on at least one end thereof for joining to a proximate support rail and said I-beam tracks include I-beam extensions on at least one end thereof for joining to a proximate I-beam track.

Another embodiment comprises a system comprising: a plurality of support rails configured for attachment to a rigid overhead structure in a parallel spaced arrangement, said support rails each having an open end and an end having a support rail extension, said support rail extensions configured to slide into an open end of, and connect to, a proximately positioned support rail; and a plurality of I-beam tracks, each I-beam track configured to slidably attach to at least two of said plurality of support rails in said parallel spaced arrangement, said I-beam tracks each having an open end and an end having an I-beam extension, said I-beam track extensions configured to slide into an open end of, and connect to, a proximately positioned I-beam track.

In one aspect, the support rails and I-beam tracks are configured such that the I-beam tracks attach to said support rails in an angled manner relative to said support rails. Such a relationship is more versatile than a simple orthogonal relationship.

In one aspect, a system is provided including: at least two tracks, each track configured to be fixed relative to a rigid overhead structure in a spaced relationship, said tracks each having lower platforms defining a path in said spaced relationship to receive and support opposite ends of one or more storage bins such that each of said tracks collectively support each of said one or more storage bins; wherein said tracks include extension members on at least one end thereof for joining to a proximate track; wherein said extension members have a rectangular cross-section and are configured to slide into an open end of said proximate track opposite an end having said extension member.

In one aspect, the system includes at least two support rails attachable to a rigid overhead structure in a space relationship, wherein the at least two tracks are configured to slidably attach to each of the at least support rails.

In one aspect, the at least two tracks are configured to fixedly attach directly to a ceiling.

In one aspect, the at least two tracks have an inverted U-shape cross-section, including an upper wall and a pair of sidewalls that extending downward therefrom, where the lower platforms extend laterally outward from a bottom of each of the sidewall, wherein an open space is defined between the sidewalls and below the upper wall.

In one aspect, the extension member is sized and configured to fit within the open space and longitudinally span the ends of two proximate tracks.

In one aspect, the extension member has a width corresponding to a width of the open space.

In one aspect, the extension member has a plurality of openings therethrough and the upper wall of the tracks has openings therethrough, wherein two proximate tracks are fixed and aligned relative to each other via a fastener extending through the openings the of the extension member and the upper wall of the track.

In one aspect, the support rail includes an internal groove extending longitudinally between the ends of the rail, wherein the support rail includes a bottom opening extending longitudinally along a bottom structure of the rail, wherein the bottom opening is narrower relative to the groove.

In one aspect, the at least two tracks are slidably secured to the support rail via a slider and a bolt, wherein the slider is sized and configured to be supported within the groove by the bottom structure of the rail, and wherein the bolt extends upward through an opening in the track and into threaded engagement with the slider.

In one aspect, tightening the bolt relative to the slider fixes the slider and track relative to the support rail, wherein loosening the bolt relative to the slider allows for sliding movement of the track relative to the rail.

In one aspect, slidable movement of the track relative to the rail adjusts the spaced relation between laterally spaced tracks to accommodate a predetermined size of the storage bin.

In one aspect, the system includes at least one hook, wherein the hook is slidably and fixably securable to the support rail.

In one aspect, the tracks and the hooks are slidably secured to the support rail via threaded engagement with a slider, wherein the slider is sized and configured to be supported within the groove by the bottom structure of the rail, wherein tightening the threaded engagement with the slider frictionally fixes the slider relative to the rail, and loosening the threaded engagement with the slider releases the slider from frictional engagement with the rail and permits slidable adjustment and variable positioning of the hook and/or track.

In one aspect, the support rails include a support rail extension member spanning proximate ends of the support rails, wherein the extension member fixes and aligns the support rails relative to each other.

In one aspect, the lower platforms that extend laterally outward from the track are opposite side portions of a lower wall member of the track.

In another aspect, a system includes: at least two support rails extending in a first longitudinal direction and attachable to a rigid overhead structure in a first fixed lateral spaced relationship; at least two tracks extending in a second longitudinal direction that is transverse to the first longitudinal direction, wherein the at least two tracks have a first state in which the tracks are slidably retained and supported by the support rails and slidable in the first longitudinal direction relative to the support rails; wherein the tracks have a second state in which the tracks are retained and fixed relative to the support rails in second fixed lateral spaced relationship that is transverse to the first lateral fixed spaced relationship; wherein the tracks each include lower platforms that extend laterally outward, wherein the tracks define a path within the second fixed lateral spaced relationship to receive and support opposite ends of one or more storage bins such that the tracks on opposite sides of the path collectively support each of said one or more storage bins via the lower platforms disposed on opposite sides of the path.

In one aspect, the support rails have an inverted C-shape including lower inner support portions defining a bottom opening extending in the first longitudinal direction and a groove extending longitudinally above the lower inner support portions and the bottom opening, wherein the tracks are supported below the lower inner support portions.

In one aspect, the tracks are supported by the support rails via a nut that is slidably disposed within the groove above the lower inner support portions and a bolt that extends through the track and into threaded engagement with the nut, wherein the nut is at least partially blocked against rotation relative to the groove, wherein the nut is slidable relative to the lower support portions in the first state and is fixed relative to the lower support portions in the second state in response to tightening the bolt against the track and providing a downward force on the nut.

In one aspect, the tracks are configured to selectively transition between the first state and the second state in response to loosening or tightening the bolt relative to the nut and the track in order to adjust and slide the tracks relative to the support rails.

In one aspect, the tracks include extension members on at least one end thereof for joining to a proximate track, wherein said extension members have a rectangular cross-section and are configured to slide into an open end of said proximate track opposite an end having said extension member.

Other variations, embodiments and features of the present invention will become evident from the following detailed description, drawings and claims.

### BRIEF DESCRIPTION OF THE DRAWINGS

FIGS. 1A and 1B illustrate a storage system installed on a ceiling according to the embodiments of the present invention;

FIGS. 2A through 2C illustrate a support rail according to the embodiments of the present invention;

FIGS. 3A through 3F illustrate an I-beam track according to the embodiments of the present invention; and

FIGS. 4A through 4D illustrate an exemplary mechanism for connecting the I-beam tracks to the support rails according to the embodiments of the present invention.

FIG. 5 illustrates another embodiment of a track attachable to the support rails or an overhead structure;

FIG. 6 illustrates a pair of tracks joined end to end including an extension member connecting the tracks;

FIG. 7 is an enlarged view of the extension member connecting the tracks;

FIG. 8 illustrates multiple extension members;

FIG. 9 illustrates an extension member attached with one track and configured to be received in an open end of a further track;

FIG. 10 illustrates an extension member attached with one support rail and configured to be received in an open end of a further track;

FIG. 11 illustrates a pair of support rails connected end to end with an extension member and further includes a hook slidably and fixably mounted to the support rail;

FIG. 12 illustrates a pair of the hooks with threaded ends and corresponding attachment device including sliders, washers, and wing-nuts;

FIG. 13 illustrates a system with support rails fixed to a ceiling and tracks slidably and fixably attached to the support rails, and further including hooks slidably and fixably attached to the support rails, and associated products/components being retained by the system.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present disclosure, as described below in more detail, involve an overhead storage system comprising broadly a series of support rails attachable to an overhead structure (e.g., ceiling) and a series of I-beam tracks movably attachable thereto allowing the I-beam tracks to slide along the support rails changing the distance between neighboring I-beam tracks to accommodate different sizes of storage bins. The components of the storage system detailed herein may be fabricated of any suitable materials including, but not limited to, metals, alloys, composites, woods, plastics, etc., and may be fabricated using any suitable technique including, but not limited to, machining, molding, machining and additive processes.

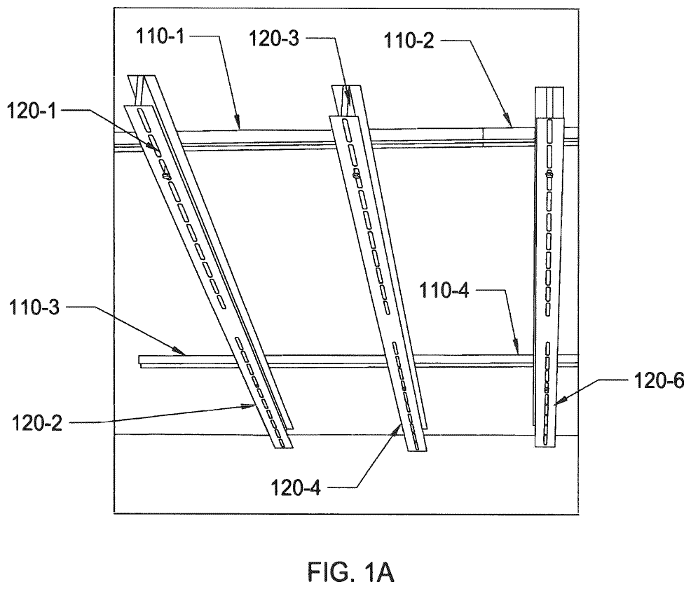

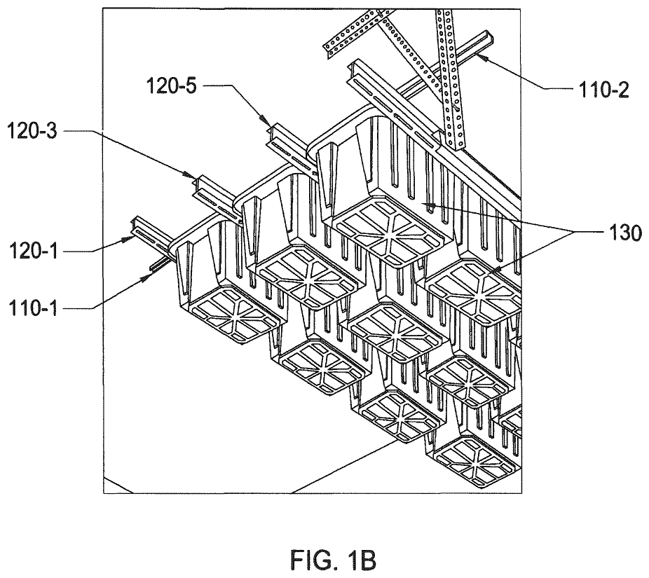

FIGS. 1A and 1B illustrate a storage system 100 installed on a ceiling according to embodiments of the present disclosure. The storage system 100 shown in FIG. 1A includes multiple support rails 110 and tracks 120, including, in one illustrated embodiment, multiple support rails 110-1 through 110-4 and multiple I-beam tracks 120-1 through 120-6. Individual supports rails 110-1 and 110-2 may be joined to create a longer collective rail 110 and individual I-beam tracks 120-1 and 120-2; 120-3 and 120-4; and 120-5 and 120-6 may be joined to create longer collective I-beam tracks 120. Individual support rails 110-1 and 110-3 in conjunction with I-beam tracks 120-1 and 120-3 may also form a complete, albeit smaller, overhead storage system.

Similarly, one or more pairs of individual support rails 110 may support pairs of longer collective I-beam tracks 120 that include multiple tracks 120 joined together. Similarly, pairs of longer collective support rails 110 that include multiple support rails 110 joined together may support one or more pairs of individual I-beam tracks 120.

FIG. 1B shows storage bins 130 hanging from neighboring I-beam tracks 120. Specifically, two lower platforms of neighboring I-beam tracks 120 slidably receive opposite ends of one or more storage bins.

As shown, the I-beam tracks 120 include both upper platforms and lower platforms that extend outward from the central vertically extending support. As described in further detail later, the I-beam tracks may be arranged to include lower platforms to support the storage bins, but may exclude upper platforms. In this regard, the shape of the I-beam track may no longer resemble an “I” and may instead resemble an upside-down “T” or an upside-down “U” having one or more outwardly extending lower platforms. Thus, it will be appreciated that referenced made herein to the I-beam tracks is applicable to other arrangements, including those cross-sectional shapes that do not include both upper and lower platforms. The tracks for supporting the storage bins may also referred to simply as “tracks.” In one aspect, the track may have an “L” shape with a single lower platform extending from the central support, for example for tracks that are configured to be placed at the outer end of a series of parallel tracks or in the case of a single pair of tracks.

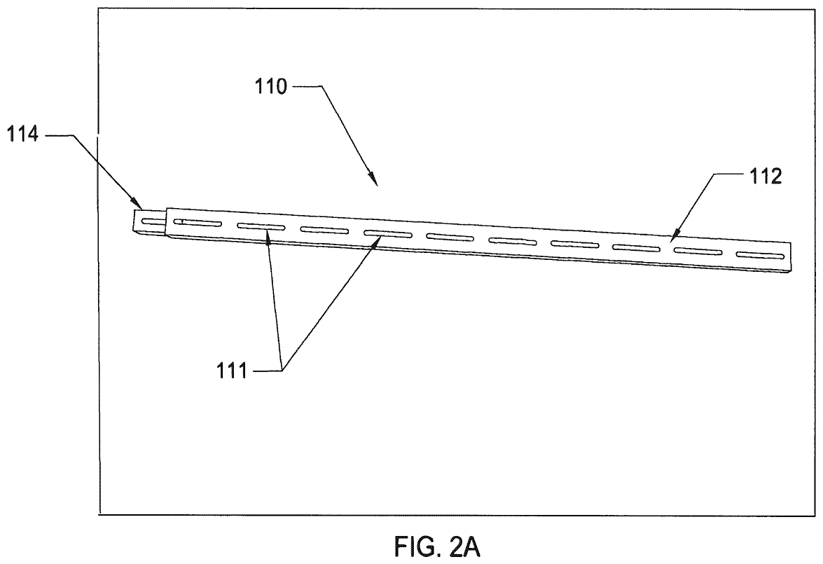

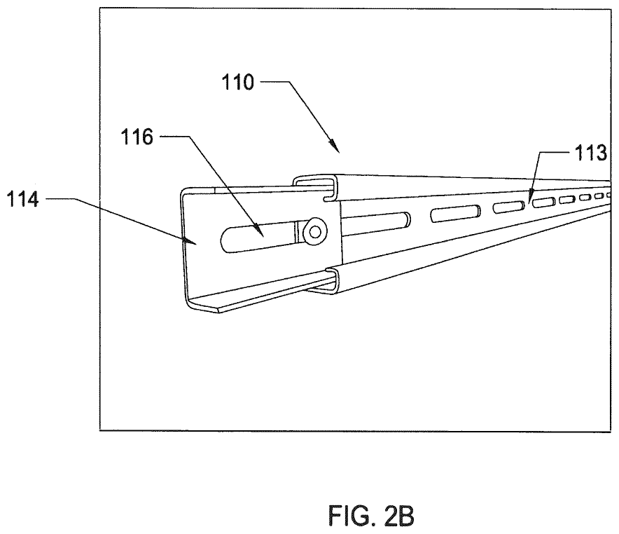

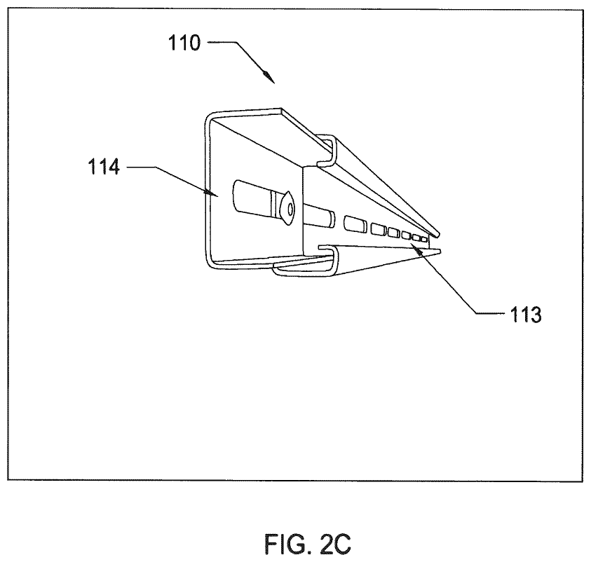

FIGS. 2A through 2C show the support rail 110 according to the embodiments of the present invention. Each support rail 110 includes a series of openings 111 along a back 112 thereof. The openings 111 facilitate attachment via screws, bolts, etc., to a ceiling or other rigid structure. An underside of the support rail 110 defines an elongated groove 113 which, as detailed below, acts as a path for adjusting the position of connected I-beam tracks 120 or other fixtures, which are described in further detail below. An extension member 114 at one end of the support rail 110 is dimensioned to slide into the groove of a second support rail to create a longer collective support rail as shown in FIGS. 1A and 1B. Other embodiments of the extension member are also possible, as further described below. For example, the extension member 114 may be configured to be attached to an outer surface of the support rail 110 rather than within the internal groove. An opening 116, which aligns with an opening 111 in an adjoining support rail, in the extension member 114 permits securing two support rails to one another via a connector means such as a nut and bolt. The opening 116 in the extension member 114 may align with the opening 111 both within the groove of the support rail, as shown in FIG. 2B, or outside of the groove when the extension member 114 is disposed outside of the rail 110. As shown in FIG. 2B, the extension member 114 has a U-shape, which generally matches the illustrated U-shape of the support rail 110. However, the extension member 114 may also have a flat plate-like shape, similar to the central connecting portion at the base of the “U” and include the openings 116 therein. Such a flat shape of the extension member 114 may be preferable when using an externally mounted extension member 114, but the plate-like extension member shape may also be utilized and preferred as an internally mounted member.

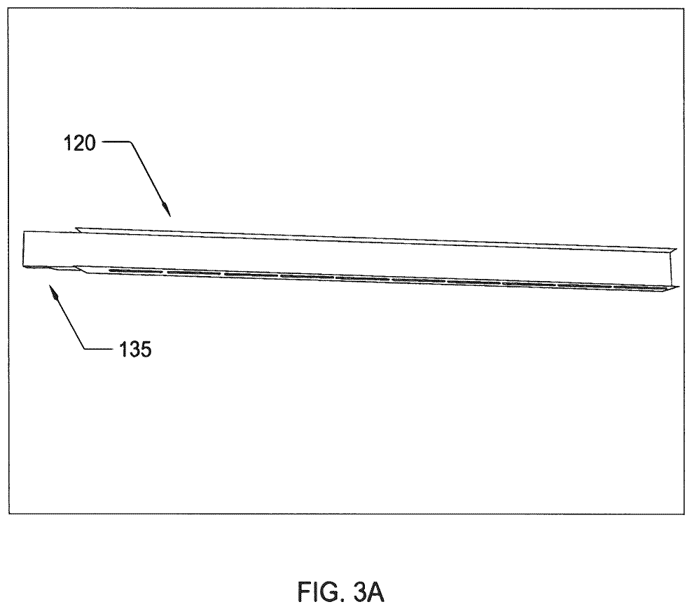

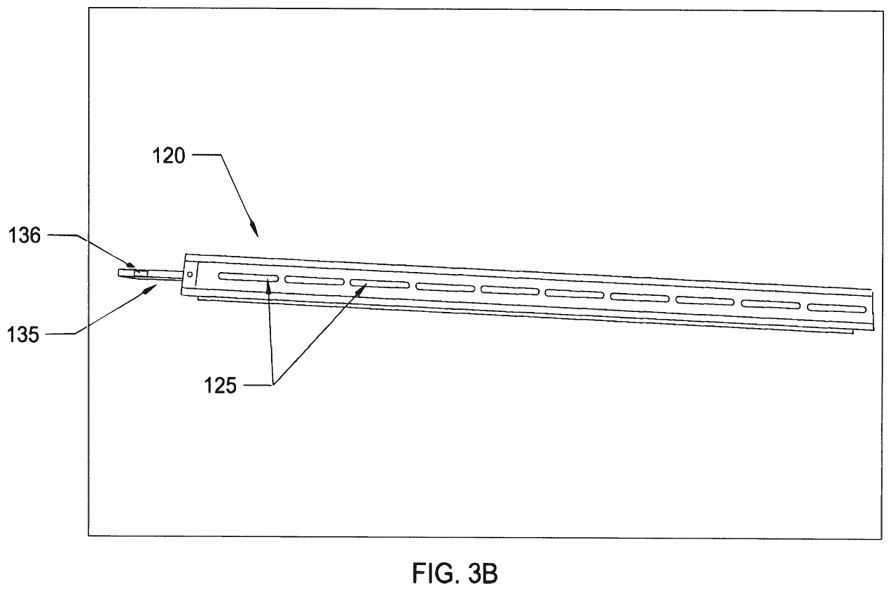

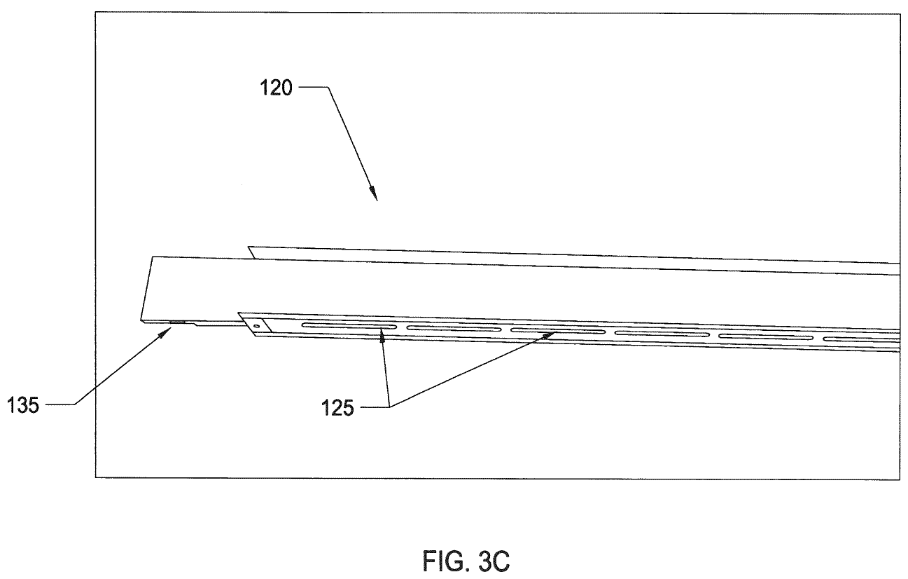

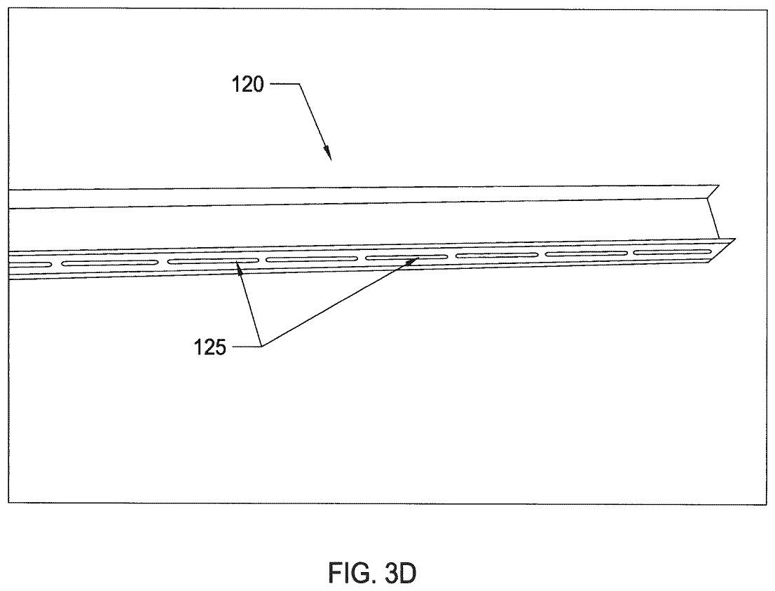

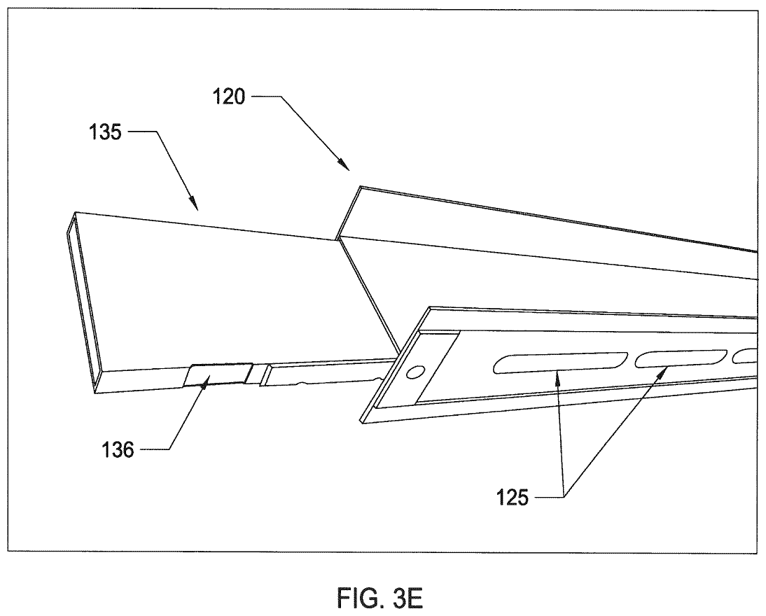

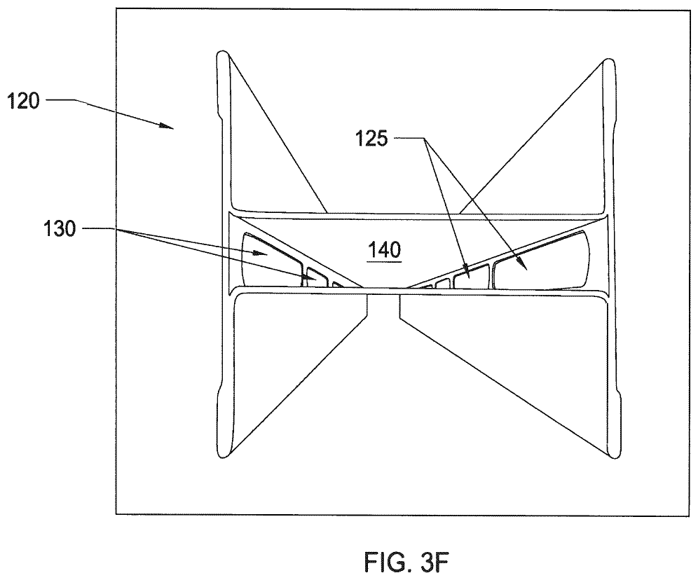

FIGS. 3A through 3F show the I-beam track 120 according to an aspect of the disclosure. The I-beam track of FIGS. 3A through 3F are illustrated having both upper and lower platforms extending to both sides. The I-beam track 120 includes a series of openings 125, 130 along opposite edges thereof through which a bolt may pass to connect the I-beam track 120 to the support rail 110 as detailed below, or to connect the I-beam track 120 directly to a ceiling or other rigid structure via screws, bolts, etc. An extension member 135 at one end of the I-beam track 120 is dimensioned to slide into a space 140 of a second I-beam track 120 to create a longer collective I-beam track 120 as shown in FIGS. 1A and 1B. An opening 136 in the extension member 135, which aligns with openings 125, 130 in an adjoining I-beam track 120, permits securing two I-beam tracks 120 to one another via a connector device such as a nut and bolt.

In one aspect, the extension member 135 has a rectangular cross-section conforming the shape of the internal space within the track 120, such that the extension member 135 can slide into the open ends of end-to-end tracks. In another aspect, the extension member 135 has a rectangular cross-section conforming to the width of the internal space within the track 120. In another aspect, the extension member 135 has a rectangular cross-section sized and configured to slide within the track 120 along an upper wall of the track 120. In one aspect, the extension member 135 has a flat plate-like shape. In another aspect, the extension member 135 includes one or more openings 136 in the form of a holes configured for a bolt to pass therethrough and further through openings 125, 130 of adjoining tracks 120.

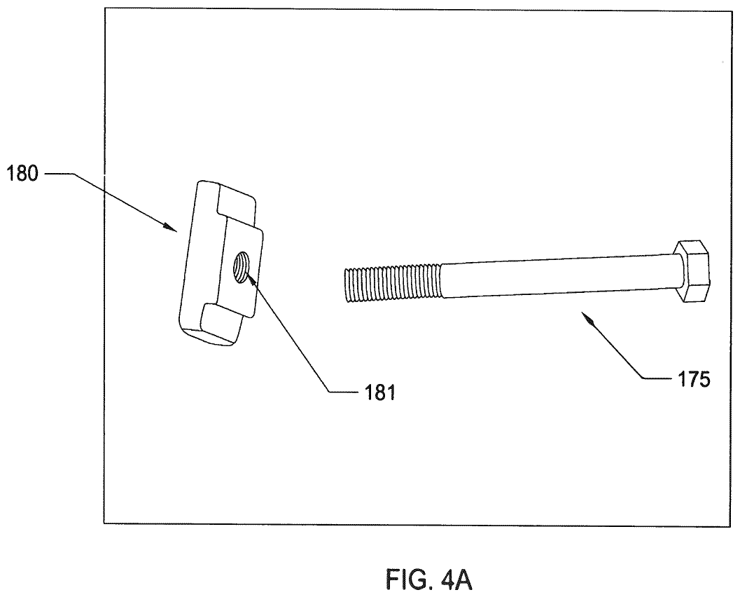

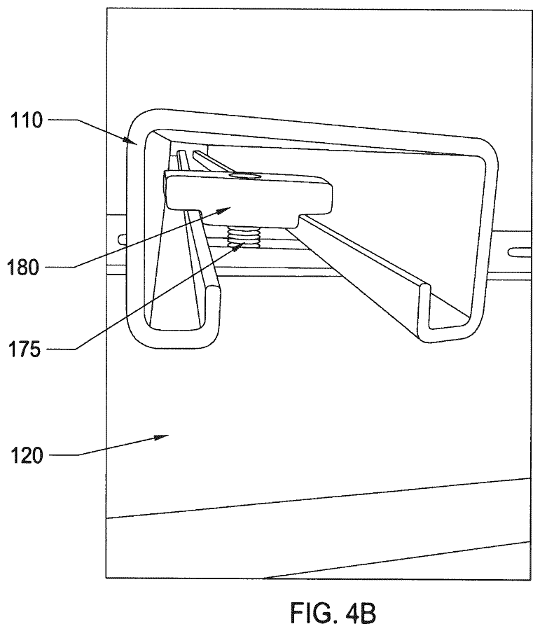

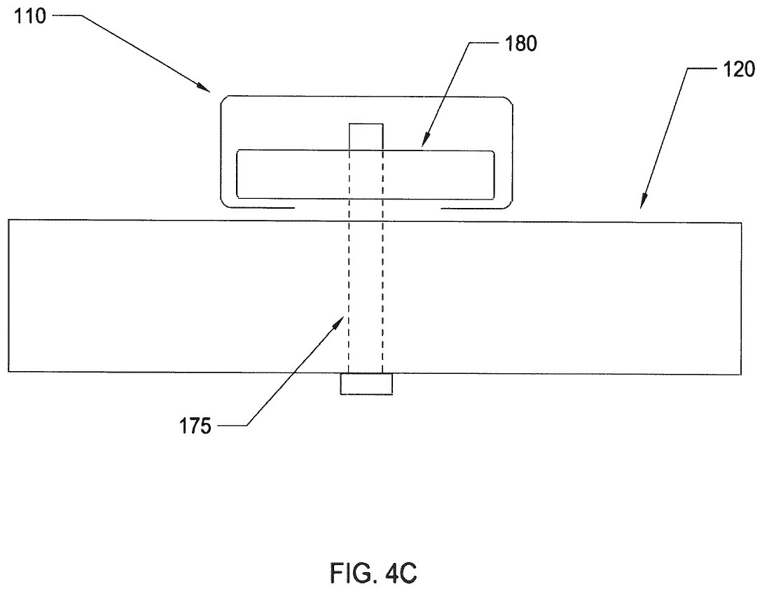

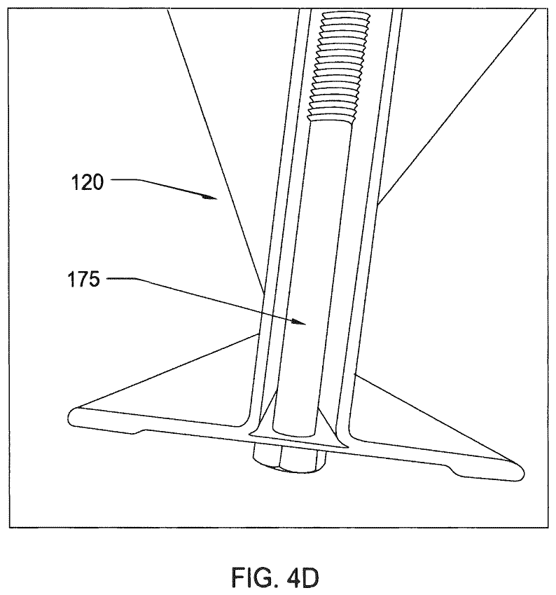

FIGS. 4A through 4D show an exemplary mechanism for connecting the I-beam tracks 120 to the support rails 110 according to the aspects of the present disclosure. A bolt 175 and slider 180 serve to slidably attach the I-beam tracks 120 to the support rails 110. The process to connect the I-beam track 120 to the support rail 110 includes: (i) sliding the bolt 175 through corresponding openings 125 and 130 in the I-beam track 120 and through the bottom opening of the groove 113 in the support rail 110; (ii) sliding the slider 180 into proper position within and along the support rail groove 113; (iii) threading the bolt 175 into threaded cavity 181 of slider 180. To secure the I-beam track 120 in place relative to the support rail 110, the bolt 175 may be tightened completely until the slider 180 creates downward pressure on the support rail 110 securing the I-beam 110 in place. Loosening the bolt 175 then permits the I-beam to once again slide along the support rail 110 for re-positioning as needed.

In the case of securing the I-beam track 120 directly to the ceiling or other rigid support structure, the bolt 175 (or screw) may similarly be inserted upward through the openings 125, 130 in the track 120 (or only a single opening in the upper wall in the case where no bottom wall is present in the track 120) and into engagement with the ceiling or other rigid support structure. In this aspect, the track 120 may not be laterally slidable, as in the attachment to the rail 110, if the ceiling or other rigid support structure does not include a slot or other groove. However, in one aspect, the ceiling may have slots or grooves to allow for sliding adjustment via the use of slider 180. Other track embodiments contemplated herein are likewise fixable directly to the ceiling or the like.

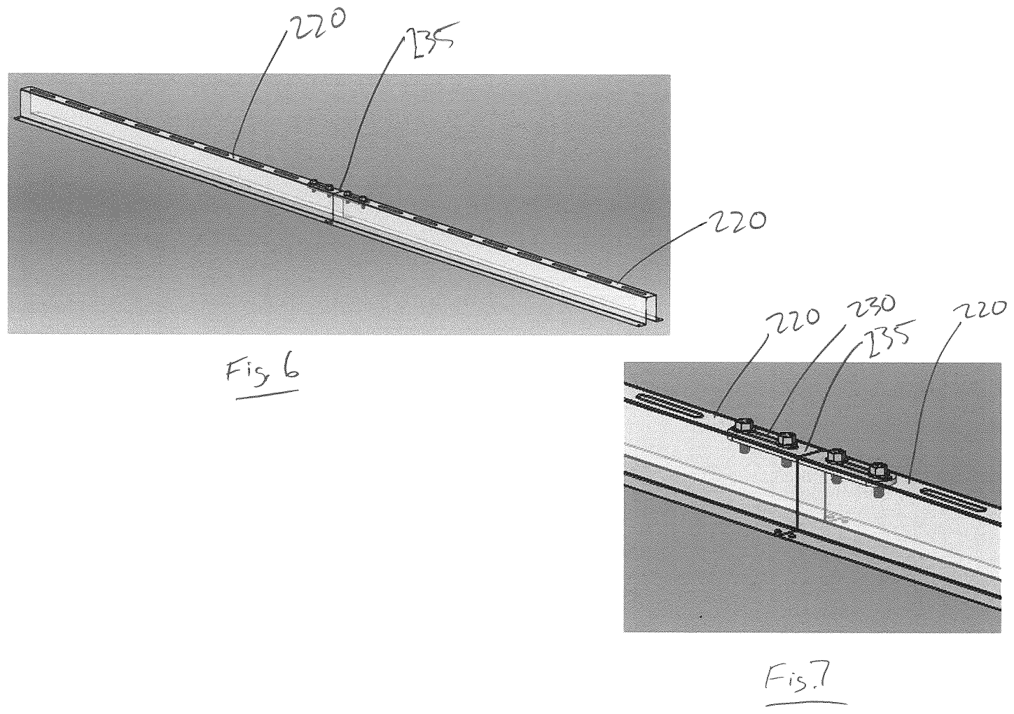

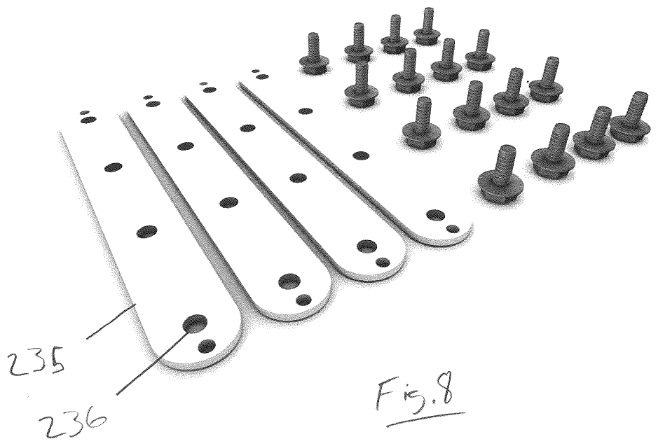

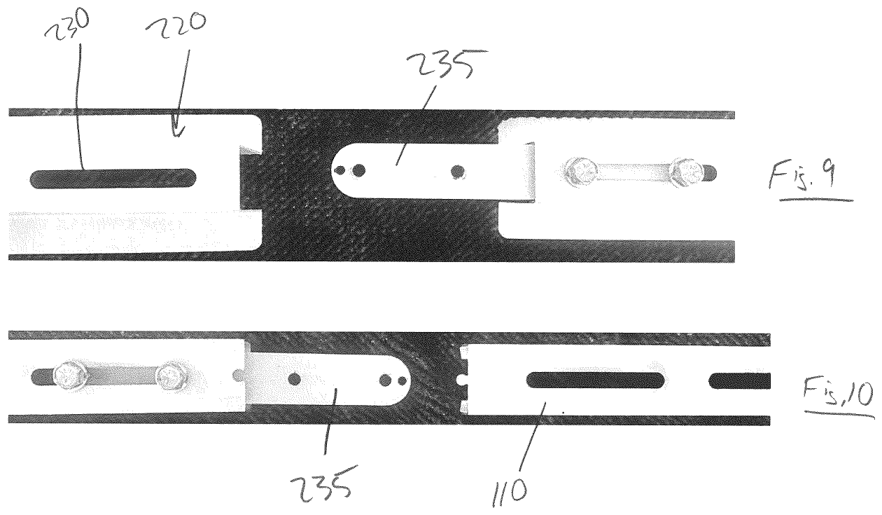

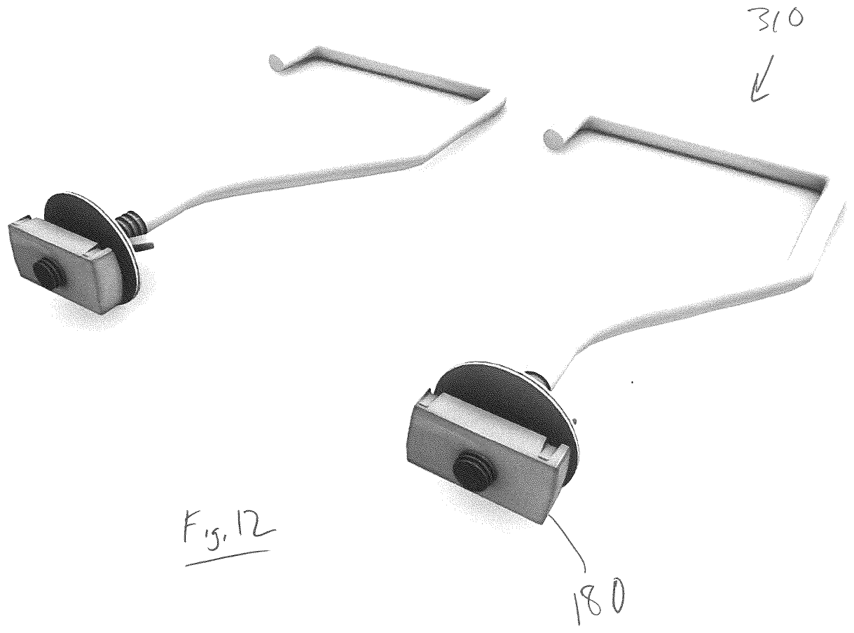

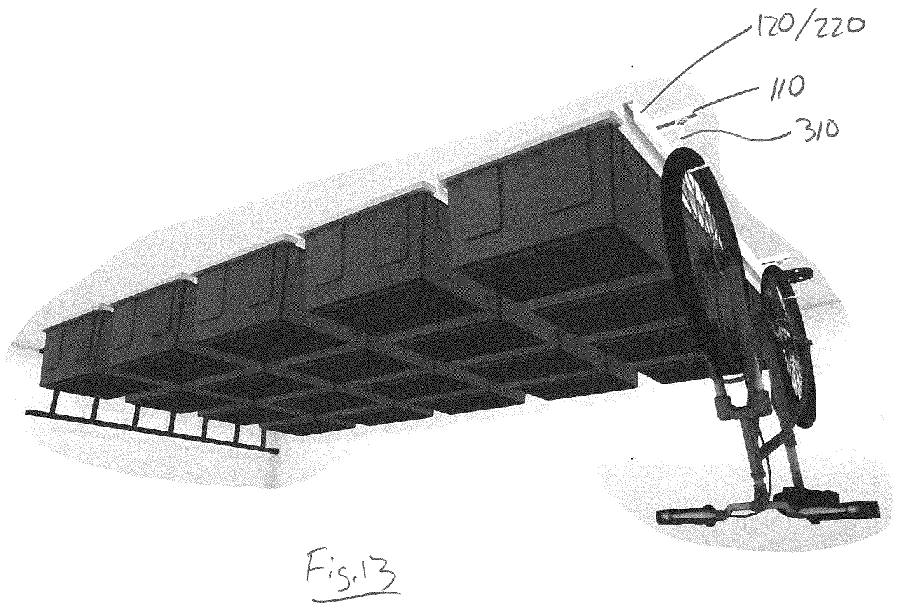

Turning now to FIGS. 5-9, track 220 is illustrated as another example of a track similar to I-beam track 120 for being spaced apart to support a storage bin or the like. Similar reference numbers to the track 120 are used for track 220, but in the 200-series. Track 220 includes an upside-down U-shape having outwardly extending lower platforms 221 that extend from the bottoms of sidewalls 222, which extend downwardly from upper wall 223. Track 220 includes openings 230 in the upper wall 223, but does not include a lower wall or lower openings. Rather, a lower opening 224 that generally runs the length of the track 220 is provided. A space 240 is defined within the track 220 between the sidewalls 222 and below the upper wall 223. This arrangement of track 220 provides for easier manufacture than track 120, in that only four corner/bends in the material are needed. Track 220 is fixable to the support rails 110 or directly to the ceiling or other rigid support structure in a similar manner, in that a bolt 175 may be guided upwardly through opening 230 and into engagement with the slider 180. A washer with a through-hole (similar to the washer shown in FIGS. 11 and 12) may be provided below and across the lower opening 224 of track 220, such that a similar length bolt 175 may be used as in track 120, or a shorter bolt may be used that is inserted up into the space 240 between the sidewalls, such as the bolts shown in FIG. 5. Thus, the track 220 provides similar functionality as that of the I-beam shaped track 120, for example with each having lower platforms, like platforms 221 or those at the bottom of track 120, configured to be placed below a flange or other projection of a storage bin or the like.

The slider 180 may have different shapes to accommodate at least partial resistance against rotation while disposed within the groove 113 defined within the rail 110. As shown throughout, the rail may have an inverted C-shape with an upper wall 110a and pair of sidewalls 110b that extend downward, and a pair of lower walls 110c that extend inwardly from the bottoms of the sidewalls 113b. The lower walls 110 may be slanted or bent upward to create a support surface that holds the slider 180 and allows the slider to translate smoothly along the lower walls. The slider may have a T-shape cross-section (as in FIG. 4B), with a neck portion sized to be received in the elongate opening 113a that is defined between the lower wall portions, and a head portion sized to be wider than the elongate opening 113a. The neck portion may provide resistance to rotation by contacting the lower wall portions, or the head portion may contact the sidewalls 110b. The slider 180 may also have a generally block type shape (as in FIG. 4C or 5) without a neck portion, with rotational resistance provided by contact with the sidewalls.

Extension member 135, described above with reference to track 120, may be disposed within space 240, similar to inserting extension member 135 within space 140 of track 120. Extension member 135 may be secured to adjoining tracks 220, via a bolt, screw or the like extending through the opening 136 of the extension member 135. Such a bolt may extend through opening 136 in the bottom surface of extension member 135, extend through extension member 135, and through opening 230 in the upper wall 223 of the track. Thus, multiple tracks 220 may be combined and linked together via the extension member 135, thereby having an extended length relative to a single track 220. The bolts could alternatively extend downward through the track 220 and extension member 135.

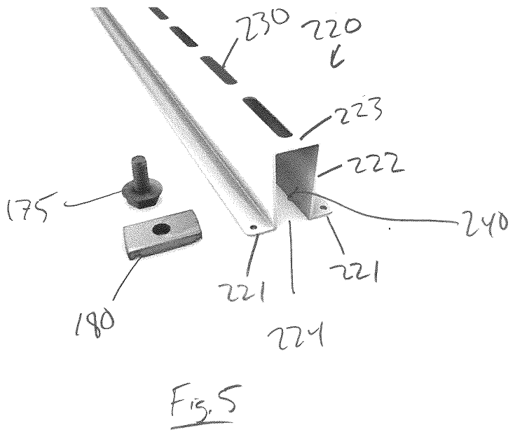

In another aspect, extension member 235 shown in FIGS. 6-9 may be used, and may be disposed within space 240 and engaged with the upper wall 223. Extension member 235 functions similarly to extension member 135, joining together the ends of adjoining tracks 220 and is configured to be received in the openings of the ends of adjoining tracks 220. Put another way, the track 220 includes extension member 235, which is received in the opening of the end of a further adjoining track 220. The extension member 235 includes one or more openings 236 through which a securing device, like a bolt or screw, may pass, such that extension member 235 is fixedly secured to one end of track 220 and configured to be received in the open end of adjoining track 220. Extension member 235 has a rectangular cross-section, and may be sized to correspond to the width of space 240 between the sidewalls 222 along the upper wall 223. Thus, multiple tracks 220 may be combined and linked together to provide an extended length track 220.

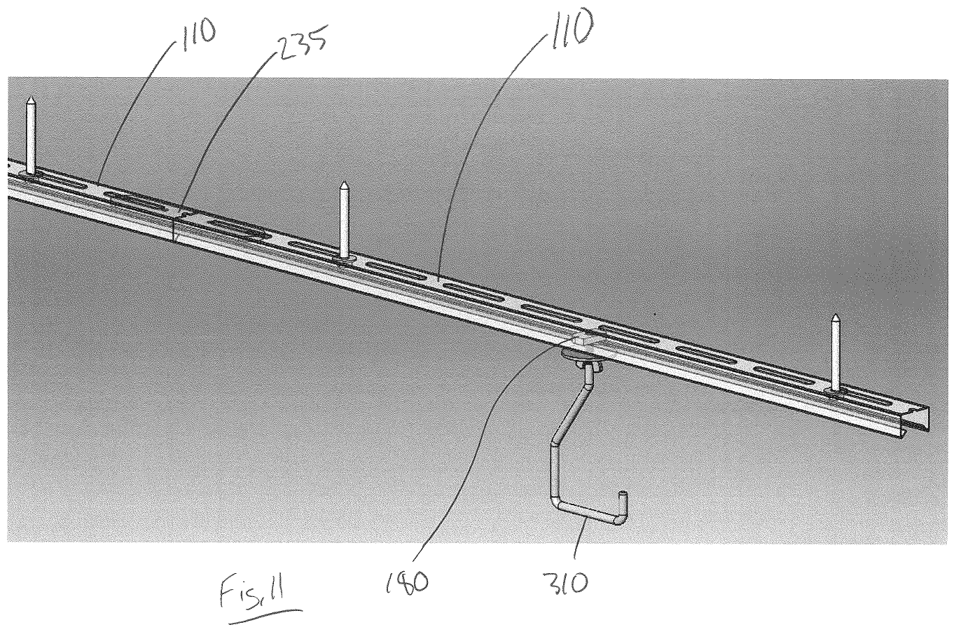

In one aspect, the same type of extension member 235 can be used to secure end-to-end adjoining rails 110 (see FIGS. 10 and 11) and can also be used to the secure adjoining tracks 220. In this aspect, the width of the space within groove 113 of the rails 110 may be approximately the same as the width of the space 240 within track 220. In one aspect, the extension member 235 may include four openings 236, with pairs of openings spaced such that they align with the openings 230 in the upper wall 223 of adjoining tracks, with two holes 236 aligned within the opening 230 of one track and two holes 236 aligned with the opening 230 of the other track 220.

Extension member 235 may have a solid rectangular cross-section that defines a plate-like shape, with the width of the plate-like shape extending across the width of the space 240 and the plate-like shape overlying the upper wall 223 of the track 220, with open space below the extension member 235. The ends of the extension member 235 may be rounded to facilitate insertion within the track 220.

With reference now to FIGS. 11-13, the system may also include additional components that may be fixed and/or slidably secured to the rails 110. For instance, the system may include hooks 310 mounted to the rails 110 in a depending manner. The hooks 310 may be secured to the rail 110 via slider 180 that is sized and configured to fit within the internal groove 113 of the rail 110. The slider 180 may have a threaded central opening 181, into which the hook may be threadably inserted. A washer-like plate may be disposed below the rail, with a wing-nut of the like also threaded onto the hook 310. With the hook 310 and the slider internal to the rail 110 in the desired position, the wing nut may be tightened against the washer-like plate, thereby fixably securing the hook 310 relative to the rail 110. To adjust the hook 310 relative to the rail the wing nut may be loosened slightly, allow the internal slider 180 to slide to another position while still retaining the hook 310. While the hook 310 may be illustrated, it will be understood that other components, such as other depending components, may be slidably secured to the rails 110 in a similar manner. To remove the hook 310, the wing nut may be loosened and the internal slider 180 may slide out of an open end of the rail 110, or the hook 310 may be unthreaded from the internal slider 180, leaving the slider 180 inside of the rail 110. The shape of slider 180 shown in FIG. 4B may also be used here.

The hooks 310 may be spaced apart from each other both along a common rail 110 or combined end-to-end rails 110, and also may be spaced apart via the lateral spacing of the rails 110 relative to each other, as in FIG. 13, shown supporting a bicycle that extends in the same direction as the tracks 120/220. The hooks 310 may be included in the system along with the tracks 120, 220, thereby providing a variety of storage functionality.

While the above description has described the extension members being utilized in both the rails 110 and the tracks 120, 220, in one aspect, the extension members may be excluded from the rails, while still including the extension members to combine the tracks 120, 220. The tracks 120, 220 function to allow the storage bins or the like to slide along the extended track length, and accordingly the connected tracks 120, 220 benefit from being connected and kept in alignment by the extension members. The rails 110, on the other hand, provide a support for the tracks 120, 220, but the tracks 120, 220 are not intended to slide along the rails 110 during normal use, but rather benefit from slight sliding during installation and positioning. Accordingly, the rails 110 may still be useful even in cases where there may be some misalignment, or where the rails 110 are not secured end-to-end. For instance, the rails 110 could, in some case, be angled relative to each other, with the tracks 120, 200 still being aligned with each other. Put another way, the rails 110 and tracks 120, 220 need not be perpendicular to each other in order to make the tracks 120, 200 parallel to each other. Further, as described previously, in some instances the tracks 120, 220 may be installed directly into the ceiling rather that to the rails 110. It will be appreciated that various advantageous aspects of the system disclosed herein may also be realized with the use of the extension members, for example the slidable adjustment of the tracks and repeatable transition between fixed states and adjustable states while being retained by the support rails.

Although the invention has been described in detail with reference to several embodiments, additional variations and modifications exist within the scope and spirit of the invention as described and defined in the following claims.

What is claimed is:

1. A system comprising:
at least two tracks, each track configured to be fixed relative to a rigid overhead structure in a spaced relationship, said tracks each having lower platforms defining a path in said spaced relationship to receive and support opposite ends of one or more storage bins such that each of said tracks collectively support each of said one or more storage bins;
wherein said tracks include extension members on at least one end thereof for joining to a proximate track;
wherein said extension members have a rectangular cross-section and are configured to slide into an open end of said proximate track opposite an end having said extension member.

2. The system of claim 1, further comprising at least two support rails attachable to a rigid overhead structure in a space relationship, wherein the at least two tracks are configured to slidably attach to each of the at least support rails.

3. The system of claim 1, wherein the at least two tracks are configured to fixedly attach directly to a ceiling.

4. The system of claim 1, wherein the at least two tracks have an inverted U-shape cross-section, including an upper wall and a pair of sidewalls that extending downward therefrom, where the lower platforms extend laterally outward from a bottom of each of the sidewall, wherein an open space is defined between the sidewalls and below the upper wall.

5. The system of claim 4, wherein the extension member is sized and configured to fit within the open space and longitudinally span the ends of two proximate tracks.

6. The system of claim 5, wherein the extension member has a width corresponding to a width of the open space.

7. The system of claim 6, wherein the extension member has a plurality of openings therethrough and the upper wall of the tracks has openings therethrough, wherein two proximate tracks are fixed and aligned relative to each other via a fastener extending through the openings the of the extension member and the upper wall of the track.

8. The system of claim 2, wherein the support rail includes an internal groove extending longitudinally between the ends of the rail, wherein the support rail includes a bottom opening extending longitudinally along a bottom structure of the rail, wherein the bottom opening is narrower relative to the groove.

9. The system of claim 8, wherein the at least two tracks are slidably secured to the support rail via a slider and a bolt, wherein the slider is sized and configured to be supported within the groove by the bottom structure of the rail, and wherein the bolt extends upward through an opening in the track and into threaded engagement with the slider.

10. The system of claim 9, wherein tightening the bolt relative to the slider fixes the slider and track relative to the support rail, wherein loosening the bolt relative to the slider allows for sliding movement of the track relative to the rail.

11. The system of claim 10, wherein slidable movement of the track relative to the rail adjusts the spaced relation between laterally spaced tracks to accommodate a predetermined size of the storage bin.

12. The system of claim 8, further comprising at least one hook, wherein the hook is slidably and fixably securable to the support rail.

13. The system of claim 12, wherein the tracks and the hooks are slidably secured to the support rail via threaded engagement with a slider, wherein the slider is sized and configured to be supported within the groove by the bottom structure of the rail, wherein tightening the threaded engagement with the slider frictionally fixes the slider relative to the rail, and loosening the threaded engagement with the slider releases the slider from frictional engagement with the rail and permits slidable adjustment and variable positioning of the hook and/or track.

14. The system of claim 2, wherein the support rails include a support rail extension member spanning proximate ends of the support rails, wherein the extension member fixes and aligns the support rails relative to each other.

15. The system of claim 1, wherein the lower platforms that extend laterally outward from the track are opposite side portions of a lower wall member of the track.

16. A system comprising:
at least two support rails extending in a first longitudinal direction and attachable to a rigid overhead structure in a first fixed lateral spaced relationship;
at least two tracks extending in a second longitudinal direction that is transverse to the first longitudinal direction, wherein the at least two tracks have a first state in which the tracks are slidably retained and supported by the support rails and slidable in the first longitudinal direction relative to the support rails;
wherein the tracks have a second state in which the tracks are retained and fixed relative to the support rails in second fixed lateral spaced relationship that is transverse to the first lateral fixed spaced relationship;
wherein the tracks each include lower platforms that extend laterally outward, wherein the tracks define a path within the second fixed lateral spaced relationship to receive and support opposite ends of one or more storage bins such that the tracks on opposite sides of the path collectively support each of said one or more storage bins via the lower platforms disposed on opposite sides of the path.

17. The system of claim 16, wherein the support rails have an inverted C-shape including lower inner support portions defining a bottom opening extending in the first longitudinal direction and a groove extending longitudinally above the lower inner support portions and the bottom opening, wherein the tracks are supported below the lower inner support portions.

18. The system of claim 17, wherein the tracks are supported by the support rails via a nut that is slidably disposed within the groove above the lower inner support portions and a bolt that extends through the track and into threaded engagement with the nut, wherein the nut is at least partially blocked against rotation relative to the groove, wherein the nut is slidable relative to the lower support portions in the first state and is fixed relative to the lower support portions in the second state in response to tightening the bolt against the track and providing a downward force on the nut.

19. The system of claim 18, wherein the tracks are configured to selectively transition between the first state and the second state in response to loosening or tightening the bolt relative to the nut and the track in order to adjust and slide the tracks relative to the support rails.

20. The system of claim 19, wherein said tracks include extension members on at least one end thereof for joining to a proximate track, wherein said extension members have a rectangular cross-section and are configured to slide into an open end of said proximate track opposite an end having said extension member.

21. The system of claim 1, further comprising at least two support rails attachable to a rigid overhead structure in a spaced relationship, wherein the at least two tracks are configured to slidably attach to each of the at least support rails.
